(19) United States
(12) Patent Application Publication
(10) Pub. No.: US 2022/0253529 A1
(43) Pub. Date: Aug. 11, 2022

(54) INFORMATION PROCESSING APPARATUS, INFORMATION PROCESSING METHOD, AND COMPUTER READABLE MEDIUM

(71) Applicant: Mitsubishi Electric Corporation, Tokyo (JP)

(72) Inventors: Aiko IWASAKI, Tokyo (JP); Kiyoto KAWAUCHI, Tokyo (JP); Atsushi KATO, Tokyo (JP); Shunya HIRAOKA, Tokyo (JP); Hideaki IJIRO, Tokyo (JP); Dai KUROTAKI, Tokyo (JP)

(73) Assignee: Mitsubishi Electric Corporation, Tokyo (JP)

(21) Appl. No.: 17/731,646

(22) Filed: Apr. 28, 2022

Related U.S. Application Data
(63) Continuation of application No. PCT/JP2020/031034, filed on Aug. 17, 2020.

(30) Foreign Application Priority Data
Dec. 24, 2019 (JP) 2019-233384

(51) Int. Cl. G06F 21/56; G06F 21/55

(52) U.S. Cl. CPC G06F 21/566; G06F 21/552; G06F 21/554

(57) ABSTRACT

An attribute selection section (101) selects as a recommended attribute, based on analysis status in a past anomaly analysis on each of a plurality of attributes of a new anomaly which is a newly detected anomaly, an attribute being recommended to be emphasized in an analysis on the new anomaly, from among the plurality of attributes. An attribute presentation section (103) presents the recommended attribute selected by the attribute selection section (101).

### CROSS-REFERENCE TO RELATED APPLICATIONS

This application is a Continuation of PCT International Application No. PCT/JP2020/031034, filed on Aug. 17, 2020, which claims priority under 35 U.S.C. § 119(a) to Patent Application No. 2019-233384, filed in Japan on Dec. 24, 2019, all of which are hereby expressly incorporated by reference into the present application.

### TECHNICAL FIELD

The present disclosure relates to an anomaly analysis.

### BACKGROUND ART

In recent years, many anomaly detection techniques (abnormality detection techniques) have been developed which learn a normal communication log or a normal terminal log, and detect a cyber-attack, using a learning result. In anomaly detection, responses need to be taken promptly after the anomaly detection. Therefore, in addition to an alert notifying of the anomaly detection, there is a demand for a function which outputs additional information and assists the responses after the anomaly detection.

For this, for example, in Patent Literature 1, a technique is disclosed which obtains a similarity degree between a first alert and a second alert notified preceding the first alert, and presents similarity degree information indicating the similarity degree.

### CITATION LIST

### Patent Literature

Patent Literature 1: WO2016/092836A

### SUMMARY OF INVENTION

### Technical Problem

The technique of Patent Literature 1 can present, for example, response history in the second alert as information which assists the responses after the anomaly detection, if the second alert similar to the first alert exists. However, if an alert similar to the first alert does not exist, the technique of Patent Literature 1 can present only the fact that the alert similar to the first alert does not exist.

That is, there is a problem that when a newly-detected anomaly is not similar to an anomaly detected in the past, the technique of Patent Literature 1 cannot present the information which assists the responses after the anomaly detection.

The present disclosure mainly aims to solve such a problem. Specifically, the present disclosure mainly aims to acquire a configuration that can present information which assists responses after anomaly detection even when a newly-detected anomaly is not similar to an anomaly detected in the past.

### Solution to Problem

An information processing apparatus according to the present disclosure includes:

an attribute selection section to select as a recommended attribute, based on analysis status in a past anomaly analysis on each of a plurality of attributes of a new anomaly which is a newly detected anomaly, an attribute being recommended to be emphasized in an analysis on the new anomaly, from among the plurality of attributes; and

an attribute presentation section to present the recommended attribute selected by the attribute selection section.

### Advantageous Effects of Invention

According to the present disclosure, it is possible to present a recommended attribute as information which assists responses after anomaly detection even when a new anomaly is not similar to an anomaly detected in the past.

### BRIEF DESCRIPTION OF DRAWINGS

FIG. 1 is a diagram illustrating a system configuration example according to a first embodiment.

FIG. 2 is a diagram illustrating a hardware configuration example of an analysis assist apparatus according to the first embodiment.

FIG. 3 is a diagram illustrating a functional configuration example of the analysis assist apparatus according to the first embodiment.

FIG. 4 is a flowchart illustrating an operation example of the analysis assist apparatus according to the first embodiment.

FIG. 5 is a flowchart illustrating the operation example of the analysis assist apparatus according to the first embodiment.

FIG. 6 is a diagram illustrating an example of an analysis-result input screen according to the first embodiment.

FIG. 7 is a diagram illustrating an example of alert information according to the first embodiment.

FIG. 8 is a diagram illustrating an example of analysis result information according to the first embodiment.

FIG. 9 is a diagram illustrating an example of base value information according to the first embodiment.

FIG. 10 is a diagram illustrating a process of generation of alert presentation information according to the first embodiment.

FIG. 11 is a diagram illustrating the process of generation of the alert presentation information according to the first embodiment.

FIG. 12 is a flowchart illustrating an operation example of an analysis assist apparatus according to a second embodiment.

FIG. 13 is a flowchart illustrating the operation example of the analysis assist apparatus according to the second embodiment.

FIG. 14 is a diagram illustrating an example of correlation value information according to the second embodiment.

FIG. 15 is a diagram illustrating an example of an analysis-result input screen according to the second embodiment.

FIG. 16 is a diagram illustrating an example of alert presentation information according to the second embodiment.

### DESCRIPTION OF EMBODIMENTS

Hereinafter, embodiments will be described with reference to the drawings.

In the following description of the embodiments and the drawings, parts assigned by the same reference numerals indicate the same parts or corresponding parts.

### First Embodiment

### ***Description of Configuration***

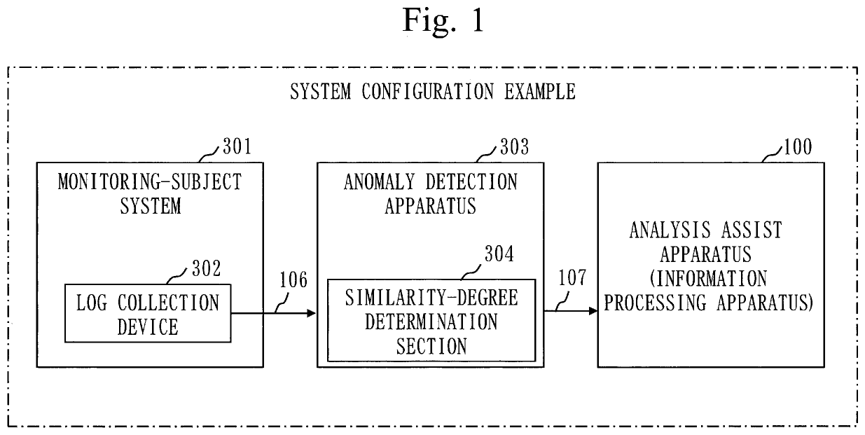

FIG. 1 illustrates a system configuration example according to the present embodiment.

As illustrated in FIG. 1, a system according to the present embodiment is configured with a monitoring-subject system 301, an anomaly detection apparatus 303, and an analysis assist apparatus 100.

The analysis assist apparatus 100 is equivalent to an information processing apparatus. Further, an operation procedure of the analysis assist apparatus 100 is equivalent to an information processing method. Further, a program which realizes operation of the analysis assist apparatus 100 is equivalent to an information processing program.

The monitoring-subject system 301 includes a log collection device 302.

The log collection device 302 collects a subject-system log 106 such as a terminal log, a communication log, or the like which are generated in the monitoring-subject system 301. Further, the log collection device 302 transmits the acquired subject-system log 106 to the anomaly detection apparatus 303.

The anomaly detection apparatus 303 includes a similarity-degree determination section 304.

The similarity-degree determination section 304 analyzes the subject-system log 106 transmitted from the log collection device 302, using a logic for determination of an anomaly (abnormality) such as a rule and machine learning and comparing the subject-system log 106 with a subject-system log acquired in the past. Then, the similarity-degree determination section 304 generates alert information 107 indicating an analysis result, and transmits the alert information 107 to the analysis assist apparatus 100.

Further, the similarity-degree determination section 304 has a function to calculate an individual abnormality degree for each of a plurality of attributes acquired from the subject-system log 106. Further, the similarity-degree determination section 304 has a function to extract past alert information similar to new alert information 107.

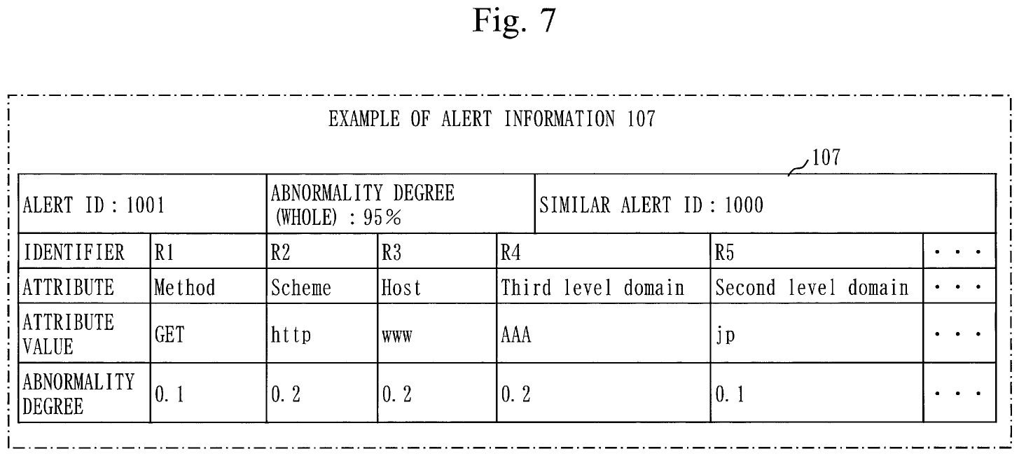

FIG. 7 illustrates an example of the alert information 107. The alert information 107 is information for notifying of an anomaly detected by the similarity-degree determination section 304.

The alert information 107 includes an alert ID (Identifier), an abnormality degree (whole), a similar-alert ID, an identifier, an attribute, an attribute value, and an abnormality degree.

The alert ID indicates an identifier that enables uniquely identifying the alert information 107.

The attribute indicates an attribute indicated in the subject-system log 106.

The attribute is a characteristic of the anomaly.

The identifier indicates an identifier which enables uniquely identifying the attribute.

The attribute value indicates a concrete value of the attribute.

The abnormality degree indicates an abnormality degree of each attribute.

The abnormality degree (whole) indicates an integrated abnormality degree of the abnormality degree of each attribute.

The similar-alert ID describes an alert ID of past alert information similar to the alert information 107. When the alert information similar to the alert information 107 does not exist, a column of the similar-alert ID is empty.

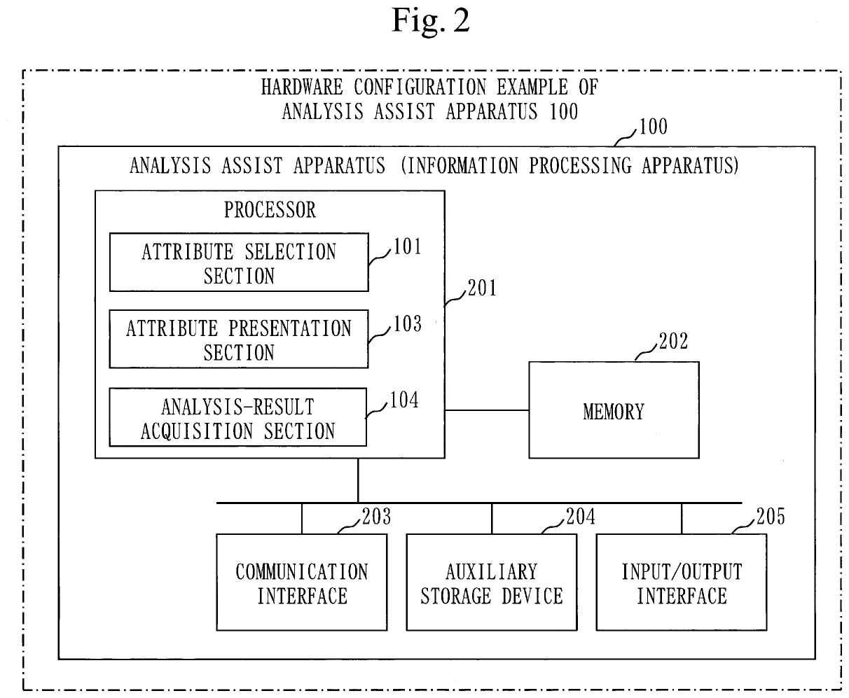

FIG. 2 illustrates a hardware configuration example of the analysis assist apparatus 100 according to the present embodiment.

The analysis assist apparatus 100 is a computer.

The analysis assist apparatus 100 includes as pieces of hardware, a processor 201, a memory 202, a communication interface 203, an auxiliary storage device 204, and an input/output interface 205.

The auxiliary storage device 204 stores programs which realize functions of an attribute selection section 101, an attribute presentation section 103, and an analysis-result acquisition section 104 which will be described later.

These programs are loaded from the auxiliary storage device 204 into the memory 202. Then, the processor 201 executes these programs, and performs operation of the attribute selection section 101, the attribute presentation section 103, and the analysis-result acquisition section 104 which will be described later.

FIG. 2 schematically illustrates a state where the processor 201 executes the programs which realize the functions of the attribute selection section 101, the attribute presentation section 103, and the analysis-result acquisition section 104.

The communication interface 203 receives the alert information 107 from the anomaly detection apparatus 303.

The input/output interface 205 presents to an analyst who uses the analysis assist apparatus 100, an analysis-result input screen 700 which will be described later. Also, the input/output interface 205 acquires input details into the analysis-result input screen 700 by the analyst. Also, the input/output interface 205 presents to the analyst, alert presentation information 1000 or alert presentation information 1001 which will be described later.

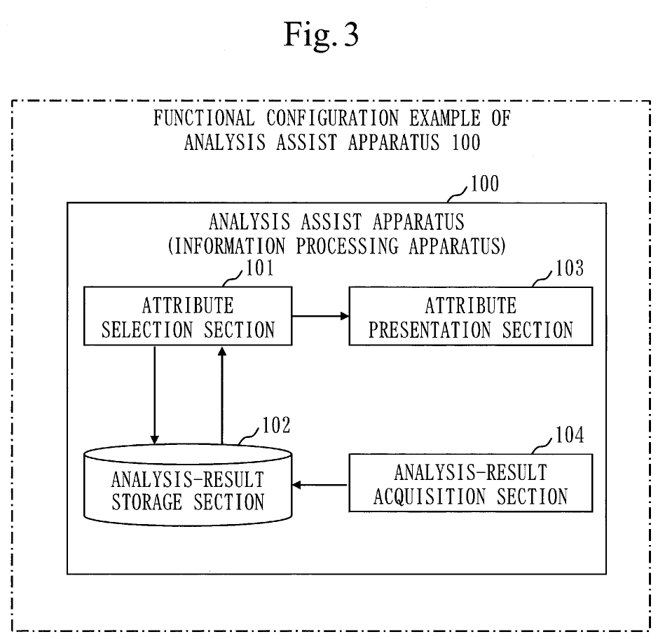

FIG. 3 illustrates a functional configuration example of the analysis assist apparatus 100 according to the present embodiment.

As illustrated in FIG. 3, the analysis assist apparatus 100 is configured with the attribute selection section 101, an analysis-result storage section 102, the attribute presentation section 103, and the analysis-result acquisition section 104.

The analysis-result storage section 102 stores analysis result information 108 and base value information 109.

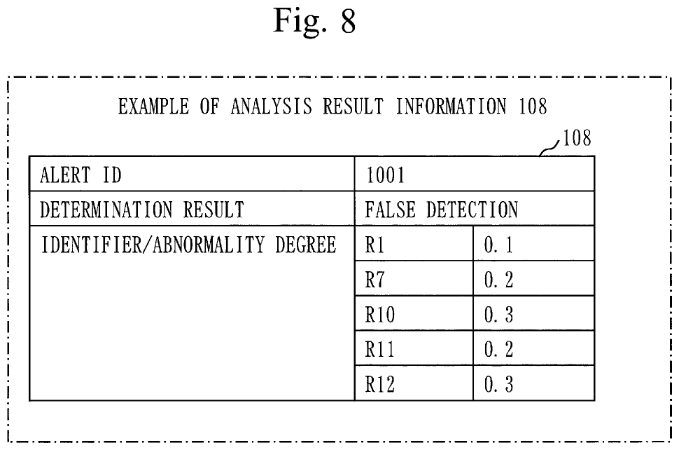

FIG. 8 illustrates an example of the analysis result information 108.

The analysis result information 108 is configured with an alert ID, a determination result, and an identifier/abnormality degree.

The alert ID indicates an alert ID of the past alert information 107 transmitted from the anomaly detection apparatus 303.

The determination result indicates a determination result made by the analyst for the past alert information 107. As a result of analyzing the alert information 107 by the analyst, when it is determined that a cyber-attack has taken place, “attack” is indicated in a column of the determination result. On the other hand, as a result of analyzing the alert information 107 by the analyst, when it is determined as false detection, “false detection” is indicated in the column of the determination result.

The identifier/abnormality degree indicates an identifier of an attribute the analyst has emphasized (focused on) when the analyst has made determination, and an abnormality degree of the identifier which has been indicated in the alert information 107.

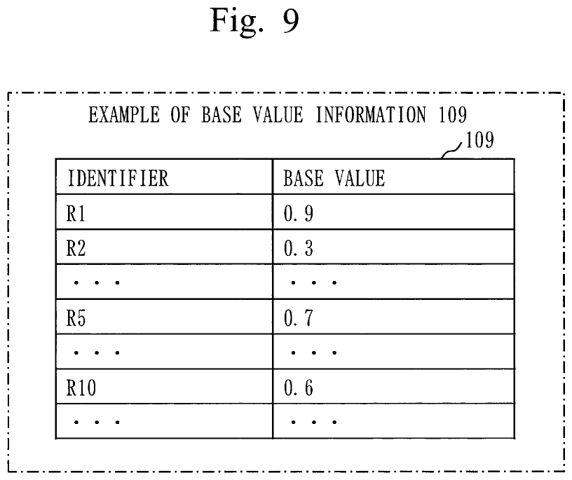

FIG. 9 illustrates an example of the base value information 109.

The base value information 109 indicates a base value for each identifier of the attribute.

The identifier indicates identifiers of attributes extracted from all pieces of alert information 107 received in the past.

The base value indicates how much emphasis has been placed on the attribute when the analyst has performed the anomaly analysis. That is, the larger the number of times the attribute is emphasized by the analyst in the past anomaly analysis is, the larger the base value of the attribute is. The anomaly analysis is a procedure for the analyst to analyze the attribute of the anomaly indicated in the alert information 107, and determine whether or not the anomaly indicated in the alert information 107 is based on the false detection or based on the cyber-attack.

When an analyst analyzes anew anomaly which is a newly-detected anomaly, the attribute selection section 101 selects as a recommended attribute, based on an analysis status in the past anomaly analysis on each of a plurality of attributes of the new anomaly, an attribute being recommended to be emphasized in the new anomaly analysis, from among the plurality of attributes. The new anomaly is an anomaly notified in the new alert information 107.

That is, the attribute selection section 101 acquires the new alert information 107 from the anomaly detection apparatus 303. Then, the attribute selection section 101 determines whether or not an alert ID of similar past alert information is indicated in the column of the similar-alert ID of the new alert information 107 acquired. That is, the attribute selection section 101 determines whether or not there exists an anomaly similar to the new anomaly, which has been detected in the past.

Then, if the alert ID is indicated in the column of the similar-alert ID of the new alert information 107, that is, if there exists the anomaly similar to the new anomaly, which has been detected in the past, the attribute selection section 101 acquires from the analysis-result storage section 102, the analysis result information 108 corresponding to the alert ID. Further, the attribute selection section 101 outputs an identifier of an attribute indicated in the acquired analysis result information 108, and the alert information 107 to the attribute presentation section 103.

On the other hand, if the alert ID is not indicated in the column of the similar-alert ID of the new alert information 107, that is, if there exists no anomaly similar to the new anomaly, which has been detected in the past, the attribute selection section 101 selects the recommended attribute from among the plurality of attributes notified in the alert information 107. Specifically, the attribute selection section 101 selects as the recommended attribute, an attribute whose base value is large in the base value information 109 from among the plurality of attributes notified in the alert information 107. Then, the attribute selection section 101 outputs an identifier of the recommended attribute selected and the alert information 107 to the attribute presentation section 103.

Note that, a process performed by the attribute selection section 101 is equivalent to an attribute selection process.

The attribute presentation section 103 generates the alert presentation information 1000 or the alert presentation information 1001 which will be described later, based on the identifier of the attribute and the alert information 107 which have been output from the attribute selection section 101. Then, the attribute presentation section 103 presents the alert presentation information 1000 or the alert presentation information 1001 to the analyst via the input/output interface 205.

A process performed by the attribute presentation section 103 is equivalent to an attribute presentation process.

The analysis-result acquisition section 104 acquires a result of the anomaly analysis on the alert information 107 from the analyst, and generates the analysis result information 108 and the base value information 109.

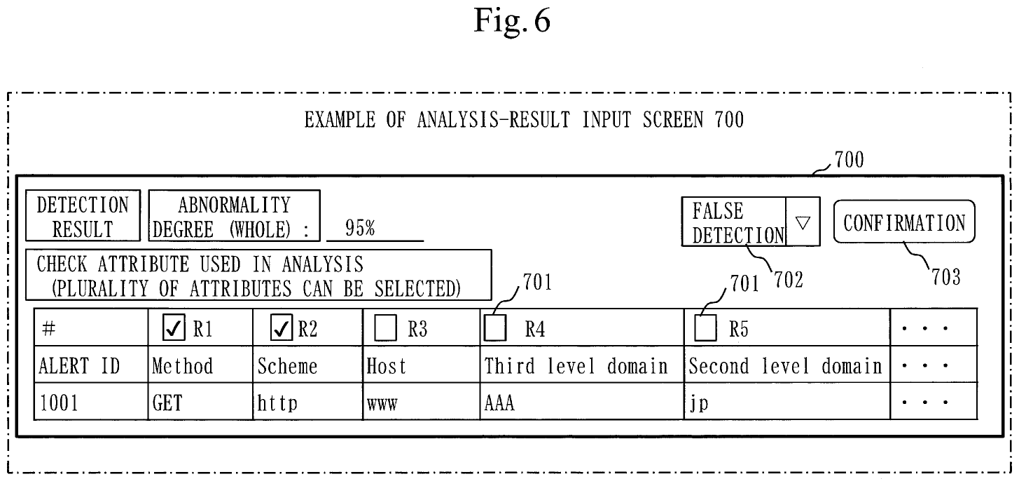

More specifically, the analysis-result acquisition section 104 presents the analysis-result input screen 700 illustrated in FIG. 6 to the analyst via the input/output interface 205. Then, the analysis-result acquisition section 104 generates the analysis result information 108 and the base value information 109 based on input details by the analyst into the analysis-result input screen 700.

Note that, details of FIG. 6 will be described later.

***Description of Operation***

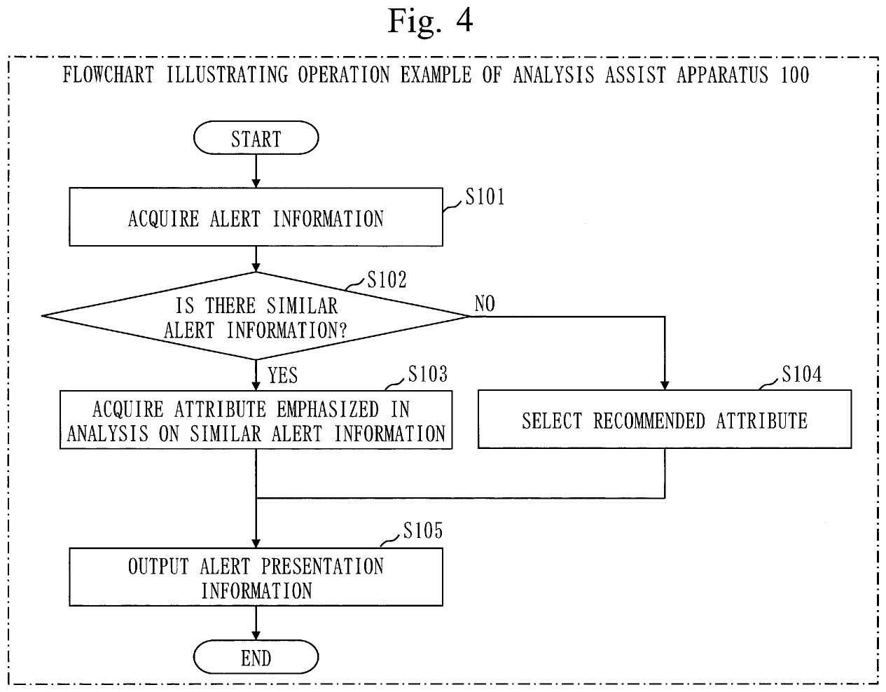

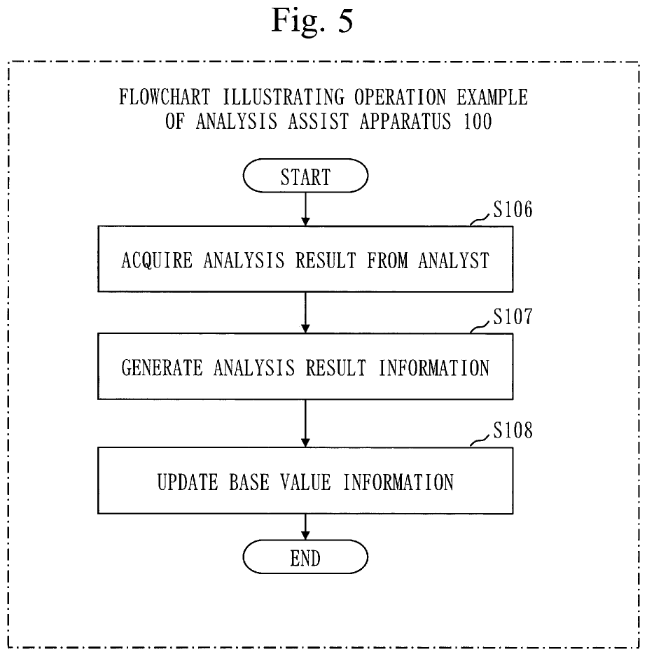

Next, with reference to FIGS. 4 and 5, operation examples of the analysis assist apparatus 100 according to the present embodiment will be described.

FIG. 4 illustrates the operation example of the analysis assist apparatus 100 when the new alert information 107 is acquired.

FIG. 5 illustrates the operation example of the analysis assist apparatus 100 when the analyst completes the anomaly analysis.

First, with reference to FIG. 4, the operation example of the analysis assist apparatus 100 when the new alert information 107 is acquired will be described.

In step S101, the attribute selection section 101 acquires the new alert information 107 from the anomaly detection apparatus 303.

Next, in step S102, the attribute selection section 101 determines whether or not there exists the analysis result information 108 of alert information similar to the alert information 107.

Specifically, the attribute selection section 101 determines whether or not the alert ID of similar past alert information is indicated in the column of the similar-alert ID of the acquired alert information 107.

When the alert ID is indicated in the column of the similar-alert ID of the acquired alert information 107 (YES in step S102), the process proceeds to step S103. On the other hand, when the alert ID is not indicated in the column of the similar-alert ID of the acquired alert information 107 (NO in step S102), the process proceeds to step S104.

In step S103, the attribute selection section 101 acquires the attribute emphasized in the analysis on the alert information similar to the alert information 107.

More specifically, the attribute selection section 101 acquires from the analysis-result storage section 102, the analysis result information 108 of the alert information similar to the alert information 107. Then, the attribute selection section 101 acquires an attribute indicated in the acquired analysis result information 108.

The attribute selection section 101 outputs the acquired attribute and the alert information 107 to the attribute presentation section 103.

In step S104, the attribute selection section 101 selects the recommended attribute.

More specifically, the attribute selection section 101 acquires the base value information 109 from the analysis-result storage section 102. Then, the attribute selection section 101 selects as the recommended attribute, an attribute whose base value is large, among the attributes included in the alert information 107.

The attribute selection section 101 selects as the recommended attribute, for example, an attribute whose base value is larger than a threshold value (for example, “0.5”), among the attributes included in the alert information 107. Alternatively, the attribute selection section 101 may select as the recommended attribute, n attributes (n is an arbitrary integer equal to or larger than two) in descending order of the base value.

The attribute selection section 101 outputs the recommended attribute selected and the alert information 107 to the attribute presentation section 103.

In step S105, the attribute presentation section 103 generates the alert presentation information, and presents the generated alert presentation information to the analyst via the input/output interface 205.

If the attribute selection section 101 outputs the attribute included in the analysis result information 108 and the alert information 107, the attribute presentation section 103 generates the alert presentation information indicating the attribute included in the analysis result information 108 and the alert information 107.

On the other hand, if the attribute selection section 101 outputs the recommended attribute and the alert information 107, the attribute presentation section 103 generates the alert presentation information indicating the recommended attribute and the alert information 107.

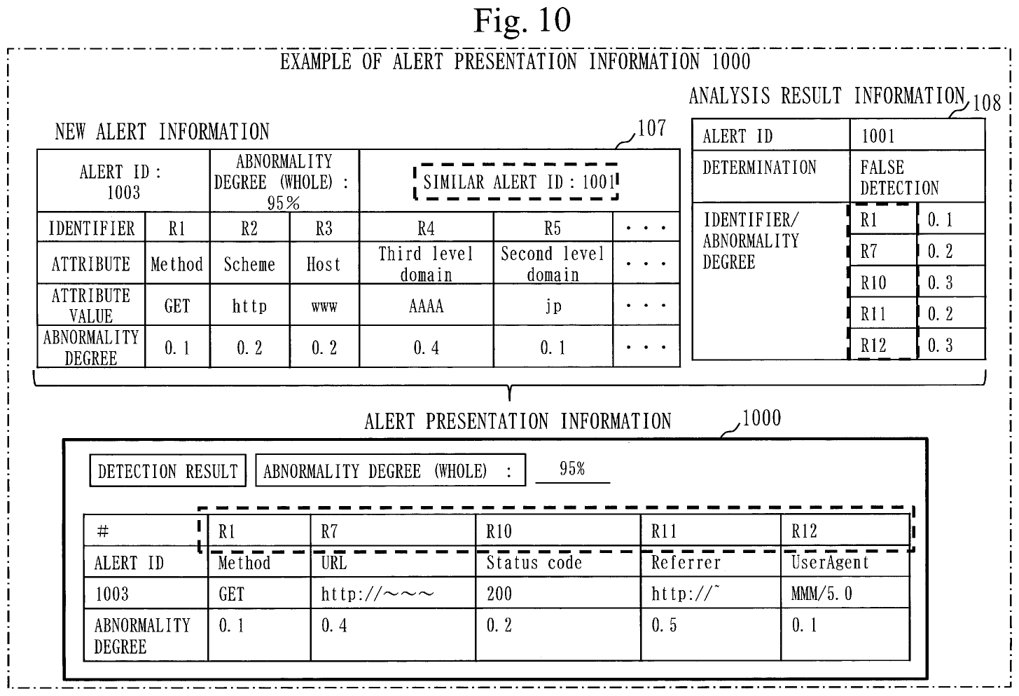

FIG. 10 explains a process of generation of the alert presentation information when the determination in step S102 in FIG. 4 is “YES”.

The attribute selection section 101 searches the analysis result information 108 of the analysis-result storage section 102, using “similar-alert ID: 1001” of the alert information 107 as a key, and extracts the analysis result information 108 indicating “alert ID: 1001”.

Then, the attribute selection section 101 extracts an identifier included in the alert information 107 from among the identifiers indicated in the extracted analysis result information 108. Here, the attribute selection section 101 extracts R1, R7, R10, R11, and R12.

The attribute selection section 101 outputs to the attribute presentation section 103, the alert information 107 and the identifiers extracted from the analysis result information 108.

The attribute presentation section 103 generates the alert presentation information 1000, using the alert information 107 and the identifiers extracted from the analysis result information 108.

The alert presentation information 1000 indicates “alert ID: 1003” and “abnormality degree (whole): 95%” of the alert information 107. Also, the alert presentation information 1000 indicates the identifiers (R1, R7, R10, R11, and R12) extracted from the analysis result information 108, and attributes and attribute values corresponding to these identifiers. Further, the alert presentation information 1000 indicates an abnormality degree corresponding to each identifier indicated in the alert information 107.

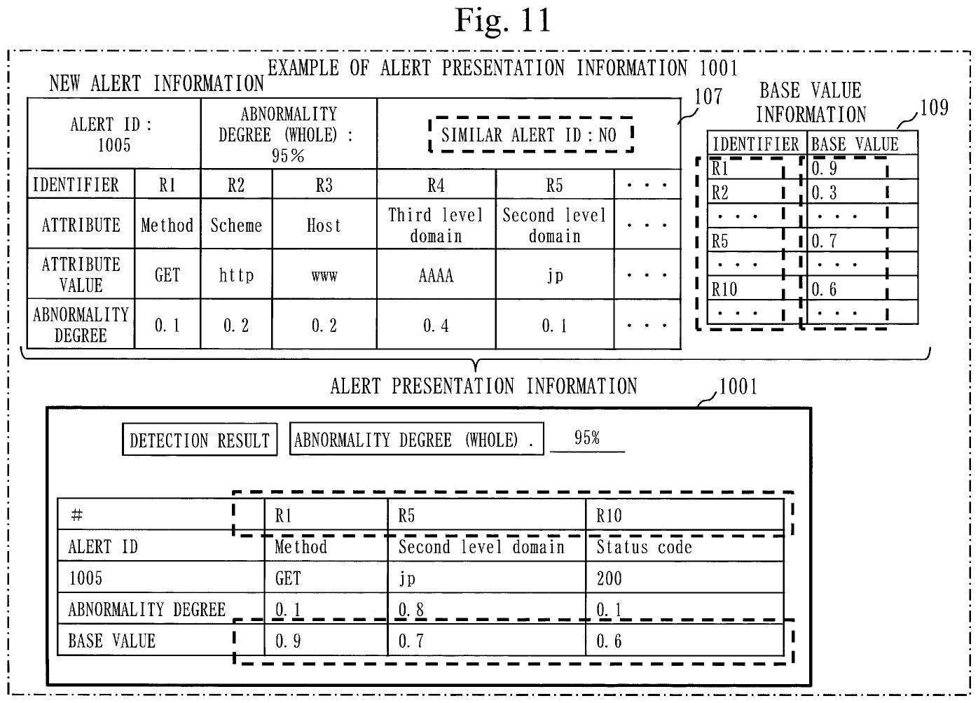

FIG. 11 explains a process of generation of the alert presentation information when the determination in step S102 in FIG. 4 is “NO”.

The attribute selection section 101 acquires the base value information 109 from the analysis-result storage section 102 for a reason of “similar-alert ID: NO” of the alert information 107.

Then, the attribute selection section 101 extracts from the base value information 109, an identifier whose base value is equal to or larger than 0.5, among the identifiers included in the alert information 107. Here, the attribute selection section 101 extracts R1, R5, and R10. Note that, attributes corresponding to these identifiers of R1, R5, and R10 are equivalent to the recommended attributes.

The attribute selection section 101 outputs to the attribute presentation section 103, the alert information 107, and the identifiers and the base values which are extracted from the base value information 109.

The attribute presentation section 103 generates the alert presentation information 1001, using the alert information 107, and the identifiers and the base values which are extracted from the base value information 109.

The alert presentation information 1001 indicates “alert ID: 1005” and “abnormality degree (whole): 95%” of the alert information 107. Further, the alert presentation information 1001 indicates the identifiers (R1. R5, and R10) extracted from the base value information 109, and attributes and attributes values corresponding to these identifiers. Further, the alert presentation information 1001 also indicates the abnormality degree corresponding to each identifier indicated in the alert information 107, and the base value corresponding to each identifier extracted from the base value information 109.

Next, with reference to FIG. 5, the operation example of the analysis assist apparatus 100 when the analyst completes the anomaly analysis will be described.

In step S106, the analysis-result acquisition section 104 acquires the analysis result of the anomaly analysis from the analyst.

More specifically, the analysis-result acquisition section 104 presents the analysis-result input screen 700 to the analyst via the input/output interface 205, and prompts the analyst to input the analysis result into necessary items of the analysis-result input screen 700.

Also, the analysis-result acquisition section 104 acquires the corresponding alert information 107 from the attribute presentation section 103.

FIG. 6 illustrates an example of the analysis-result input screen 700 corresponding to the alert information 107 (alert ID: 1001) illustrated in FIG. 7.

The analysis-result input screen 700 indicates “alert ID: 1001” of the alert information 107. Also, the analysis-result input screen 700 indicates “abnormality degree (whole): 95%” included in the alert information 107. Further, the analysis-result input screen 700 indicates the identifiers (R1, R2, R3, and the like), the attributes (Method, Scheme, Host, and the like), and the attribute values (GET, http, www, and the like) indicated in the alert information 107.

Further, a check box 701 is given for each identifier. The analyst checks the check box 701 of the identifier of the attribute the analyst has emphasized (focused on) in the anomaly analysis. The analysis can select a plurality of check boxes.

Further, the analyst designates a determination result as to whether or not there is a cyber-attack, by operating a pull-down list 702. FIG. 6 indicates “false detection”, but the analyst can select “false detection” or “attack” by pull-down.

The analyst presses a confirmation button 703 after the input details are finalized.

Note that, in FIG. 6, a pull-down form and a check-box form are adopted as examples, however, it does not matter what input forms are adopted on the analysis-result input screen 700.

Next, in step S107, the analysis-result acquisition section 104 generates the analysis result information 108.

More specifically, the analysis-result acquisition section 104 generates the analysis result information 108 illustrated in FIG. 8, using the identifier (whose check box 701 is checked) selected by the analyst on the analysis-result input screen 700, the corresponding abnormality degree, the determination result as to whether or not there is a cyber-attack designated on the pull-down list 702, and the alert ID.

That is, the analysis-result acquisition section 104 writes on the analysis result information 108, the alert ID indicated on the analysis-result input screen 700. Also, the analysis-result acquisition section 104 writes on the analysis result information 108, the determination result designated on the pull-down list 702 of the analysis-result input screen 700. Also, the analysis-result acquisition section 104 writes on the analysis result information 108, the identifier whose check box is checked on the analysis-result input screen 700. Also, the analysis-result acquisition section 104 writes on the analysis result information 108, the abnormality degree indicated in the alert information 107.

Then, the analysis-result acquisition section 104 stores the generated analysis result information 108 and the alert information 107 in the analysis-result storage section 102.

Next, in step S108, the analysis-result acquisition section 104 updates the base value information 109.

More specifically, the analysis-result acquisition section 104 calculates a base value of the identifier whose check box is checked on the analysis-result input screen 700, and updates the base value information 109.

The analysis-result acquisition section 104 calculates the base value for each identifier according to (equation 1) below.

the total number of times the identifier has been emphasized (focused on)/the total number of times the alert information has been issued (equation 1)

In (equation 1), “the total number of times the identifier has been emphasized (focused on)” is the total number of times the check box has been checked on the analysis-result input screen 700 so far. The analysis-result storage section 102 stores “the total number of times the identifier has been emphasized (focused on)” before implementation of step S108. The analysis-result acquisition section 104 acquires from the analysis-result storage section 102, “the total number of times the identifier has been emphasized (focused on)” before implementation of step S108, adds one to acquired “the total number of times the identifier has been emphasized (focused on)”, and acquires latest “the total number of times the identifier has been emphasized (focused on)”.

Also, in (equation 1), “the total number of times the alert information has been issued” is the total number of pieces of alert information issued by the anomaly detection apparatus 303 so far. The attribute selection section 101 counts up “the total number of times the alert information has been issued” every time the alert information 107 is received. Then, the analysis-result storage section 102 stores “the total number of times the alert information has been issued” counted by the attribute selection section 101. The analysis-result acquisition section 104 acquires “the total number of times the alert information has been issued” from the analysis-result storage section 102, and calculates the base value for each attribute according to (equation 1).

Thereafter, the analysis-result acquisition section 104 stores in the analysis-result storage section 102, the base value information 109 indicating the updated base value.

***Description of Effect of Embodiment***

According to the present embodiment, it is possible to present the recommended attribute as information which assists the anomaly analysis of the analyst, even when there exists no past alert information similar to the alert information 107.

The present embodiment is effective especially for a case where an inexperienced analyst analyzes the alert information 107.

For example, a case is considered where an anomaly detection logic in the anomaly detection apparatus 303 is not well-developed. In this case, until the logic is reviewed, there is a possibility that the anomaly detection apparatus 303 presents an attribute which is not often used by the analyst for determining whether or not there is an attack, as an attribute which has largely contributed to the detection of the anomaly. Also, in an analysis on a log, the attribute which has contributed to the detection of the anomaly may differ from a characteristic which is used for analyzing whether or not there is an attack.

For example, when the anomaly detection apparatus 303 detects an anomaly that “accesses to a website which is usually not accessed have increased”, the attributes which have largely contributed to the detection of the anomaly are considered to be “access destination” and “the number of accesses”. When the analyst performs a log analysis on whether this anomaly is due to an attack (malware) or false detection, it is necessary to examine whether the accesses have increased due to dubious access destination or the accesses have increased due to user operation. In order to examine this, first, the analyst examines “access destination”, “referrer”, and the like. Thus, “the number of accesses” recognized by the anomaly detection apparatus 303 as the attribute which has largely contributed to the detection of the anomaly is not used for analyzing whether or not there is an attack. On the other hand, “referrer” which is not recognized by the anomaly detection apparatus 303 as the attribute which has largely contributed to the detection of the anomaly is focused on in the analysis on whether or not there is an attack. As described above, the attribute which has contributed to the detection of the anomaly and the attribute which is used for analyzing on whether or not there is an attack are not necessarily the same.

In another example, when the anomaly detection apparatus 303 detects an anomaly that “the website is accessed at a time when the website is not usually accessed”, the attribute which has largely contributed to the detection of the anomaly is considered to be “time”. However, as described above, first, the analyst examines “access destination”, “referrer”, and the like. Thus, also in this example, the attribute which has contributed to the detection of the anomaly and the attribute which is used for analyzing whether or not there is an attack are not the same.

Therefore, in order to determine whether or not there is an attack, it is necessary to present also attributes other than the attribute which has largely contributed to the detection of the anomaly. Even if all attributes are presented, an unexperienced analyst ends up analyzing all the attributes in order, which is inefficient.

In the present embodiment, since an attribute emphasized (focused on) by an experienced analyst in the past analysis on whether or not there is an attack is presented as the recommended attribute, even an inexperienced analyst can efficiently analyze whether or not there is an attack, focusing on the recommended attribute.

### Second Embodiment

In the present embodiment, mainly matters different from the first embodiment will be described.

Note that, matters not described below are the same as the first embodiment.

In the second embodiment, an example will be described of selecting as the recommended attribute, in addition to the attribute whose base value is large, an attribute whose base value is not large but whose abnormality degree is large, which has strong correlation with the determination result that an attack has taken place, when there is no past alert information similar to the new alert information 107.

***Description of Configuration***

Also, in the present embodiment, a system configuration example is as illustrated in FIG. 1.

Further, a hardware configuration example of the analysis assist apparatus 100 is as illustrated in FIG. 2, and a functional configuration example of the analysis assist apparatus 100 is as illustrated in FIG. 3.

However, in the present embodiment, the analysis-result storage section 102 stores correlation value information 110 exemplified in FIG. 14. The correlation value information 110 indicates a correlation value for each identifier of the attribute. The correlation value represents a correlation between magnitude of the abnormality degree and the determination result that an attack has taken place. That is, when the alert information 107 indicates the attribute whose abnormality degree is large, and the correlation value of the attribute is large, it is assumed that the cyber-attack has likely taken place.

The attribute selection section 101 selects as the recommended attribute, in addition to the attribute whose base value is large, an attribute presumed, based on the past anomaly analysis by the analyst, to be related with the cyber-attack when the abnormality degree is large. More specifically, the attribute selection section 101 selects as the recommended attribute, an attribute whose base value is not large but whose abnormality degree is large, which has a strong correlation between the abnormality degree and the determination result that an attack has taken place. The attribute selection section 101 refers to the correlation value information 110 stored in the analysis-result storage section 102, and extracts the attribute which has a strong correlation with the determination result that an attack has taken place.

***Description of Operation***

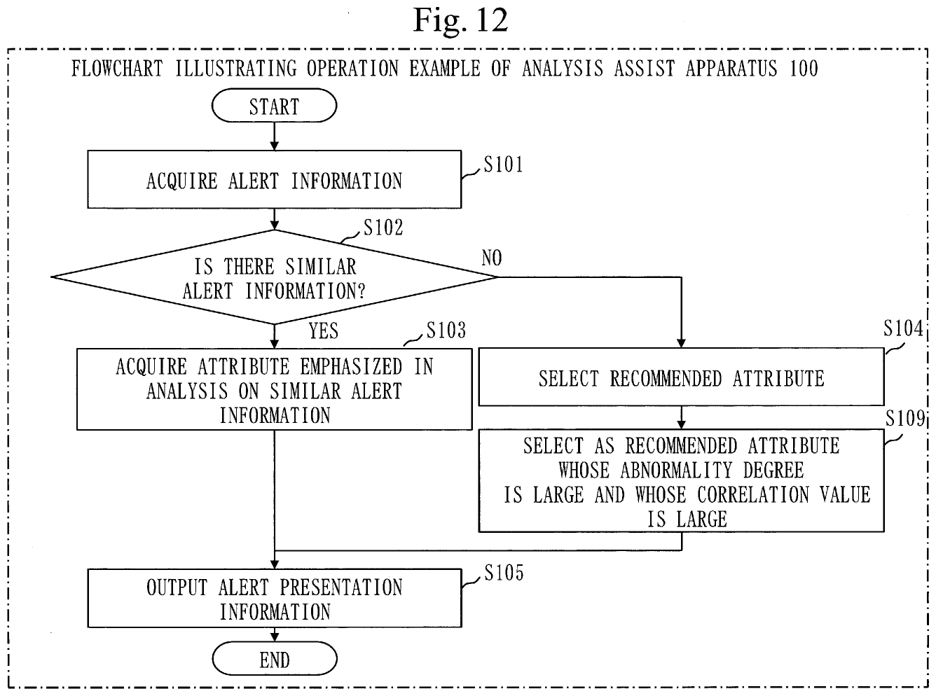

FIG. 12 illustrates an operation example of the analysis assist apparatus 100 when the new alert information 107 is acquired, according to the present embodiment.

In FIG. 12, since steps S101 to S104 are the same as those illustrated in FIG. 4, descriptions will be omitted.

In step S109, the attribute selection section 101 selects as the recommended attribute, an attribute whose abnormality degree indicated in the alert information 107 is large, whose correlation value indicated in the correlation value information 110 is large, among attributes not selected in step S104.

Specifically, the attribute selection section 101 extracts an attribute indicating a larger abnormality degree than a threshold value in the new alert information 107, among the attributes not selected in step S104. Then, if the correlation value of the extracted attribute is larger than a threshold value, the attribute selection section 101 selects the attribute as the recommended attribute.

In step S105, if the attribute presentation section 103 outputs the alert presentation information 1001, the attribute presentation section 103 reflects on the alert presentation information 1001, the recommended attribute selected in step S104 and the recommended attribute selected in step S109.

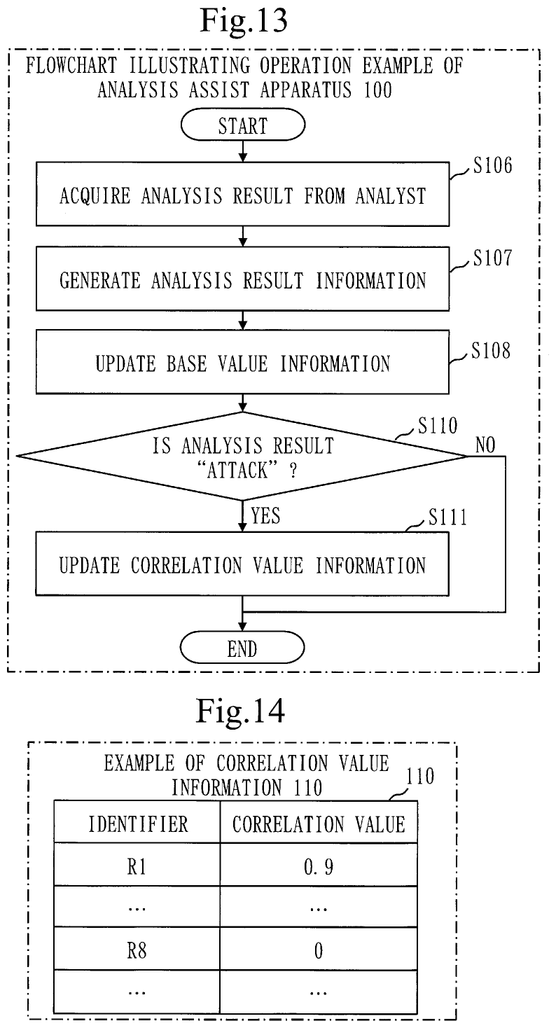

FIG. 13 illustrates an operation example of the analysis assist apparatus 100 when the analyst completes the anomaly analysis, according to the present embodiment.

In FIG. 13, sine steps S106 to S108 are the same as those illustrated in FIG. 5, descriptions will be omitted.

In step S110, the analysis-result acquisition section 104 determines whether or not the analysis result by the analyst is “attack”.

Specifically, the analysis-result acquisition section 104 examines whether the analysis result designated on the pull-down list 702 on the analysis-result input screen 700 illustrated in FIG. 6 is “attack” or “false detection”. When the analysis result is “attack” (YES in step S110), the process proceeds to step S111. On the other hand, when the analysis result is “false detection” (NO in step S110), the process ends.

In step S111, the analysis-result acquisition section 104 updates the correlation value information 110.

More specifically, the analysis-result acquisition section 104 updates the correlation value based on the abnormality degree of the alert information 107 determined by the analyst as “attack”, and generates the correlation value information 110 indicating the updated correlation value.

For example, the analysis-result acquisition section 104 calculates the correlation value for each attribute according to (equation 2) below.

The total number of pieces of alert information having abnormality degree of an attribute being equal to or larger than 0.5 and having been determined as “attack”/the total number of pieces of alert information including the attribute (equation 2)

In (equation 2), “the total number of pieces of alert information having abnormality degree of an attribute being equal to or larger than 0.5 and having been determined as “attack”” is the total number of pieces of alert information which includes an attribute (for example, an attribute of R1) subject to calculation, has abnormality degree of the attribute (the attribute of R1) being equal to or larger than 0.5, and has been determined by the analyst as “attack” on the analysis-result input screen 700.

The analysis-result storage section 102 stores “the total number of pieces of alert information having abnormality degree of an attribute being equal to or larger than 0.5 and having been determined as “attack”” before implementation of step S111. The analysis-result acquisition section 104 acquires from the analysis-result storage section 102, “the total number of pieces of alert information having abnormality degree of an attribute being equal to or larger than 0.5 and having been determined as “attack”” before implementation of step S111. Then, the analysis-result acquisition section 104 adds one to acquired “the total number of pieces of alert information having abnormality degree of an attribute being equal to or larger than 0.5 and having been determined as “attack””, and acquires latest “the total number of pieces of alert information having abnormality degree of an attribute being equal to or larger than 0.5 and having been determined as “attack””.

Further, in (equation 2), “the total number of pieces of alert information including the attribute” is the total number of pieces of alert information 107 including the attribute (for example, the attribute of R1) subject to the calculation. “the total number of pieces of alert information including the attribute” covers all pieces of alert information 107 indicating the attribute (for example, the attribute of R1) (also covers the alert information 107 whose abnormality degree is smaller than 0.5 and the alert information 107 which has been determined by the analyst as “false detection”).

The analysis-result storage section 102 stores “the total number of pieces of alert information including the attribute” before implementation of step S111. The analysis-result acquisition section 104 acquires from the analysis-result storage section 102. “the total number of pieces of alert information including the attribute” before implementation of step S111. Then, the analysis-result acquisition section 104 adds one to acquired “the total number of pieces of alert information including the attribute”, and acquires latest “the total number of pieces of alert information including the attribute”.

Then, the analysis-result acquisition section 104 calculates the correlation value for each attribute according to (equation 2).

Thereafter, the analysis-result acquisition section 104 stores in the analysis-result storage section 102, the correlation value information 110 indicating the updated correlation value. Further, the analysis-result acquisition section 104 stores latest “the total number of pieces of alert information having abnormality degree of an attribute being equal to or larger than 0.5 and having been determined as “attack”” and latest “the total number of pieces of alert information including the attribute” in the analysis-result storage section 102.

***Description of Effect of Embodiment***

As described above, in the present embodiment, when the attribute which is found, based on the past anomaly analysis, to have the strong correlation with the attack if an abnormality degree is large, appears with a large abnormality degree in the alert information 107, it is possible to present also the attribute as the recommended attribute to the analyst.

Therefore, according to the present embodiment, when an attribute usually not focused on in the anomaly analysis is likely related with the attack, it is possible to employ also the attribute as the subject of the anomaly analysis.

For example, when the anomaly analysis is often performed focusing on “access destination” and “referrer”, base values of “access destination” and “referrer” become large. Therefore, according to the first embodiment, only “access destination” and “referrer” are selected as the recommended attributes.

When an anomaly detection logic in the anomaly detection apparatus 303 is not well-developed, it is assumed that the false detection occurs often. For this reason, when the analyst examines “access destination” and “referrer” to find that these are normal, the analyst judges the anomaly as “false detection”.

Even when the anomaly detection logic is not well-developed, it is assumed that for example, as to “the number of accesses”, there is a correlation between the magnitude of the abnormality degree and correct determination that an attack takes place. Here, a case is assumed in which the anomaly of “increase of accesses to a general website” is detected. In this case, the attribute which has contributed to the anomaly detection is considered to be “the number of accesses”. In the present embodiment, since “the number of accesses” is presented as the recommended attribute, in addition to “access destination” and “referrer”, the analyst can perform an analysis focusing on “the number of accesses” even when “access destination” and “referrer” are normal. For example, the analyst can perform an analysis, assuming a possibility of attack communication under a cloak of the general website.

### Third Embodiment

In the present embodiment, mainly matters different from the first embodiment will be described.

Note that, matters not described below are the same as those in the first embodiment.

In the present embodiment, an example will be described of presenting to the analyst, an analysis method for each attribute which has been performed in the past anomaly analysis.

Also, in the present embodiment, a system configuration example is as illustrated in FIG. 1.

Also, a hardware configuration example of the analysis assist apparatus 100 is as illustrated in FIG. 2, and a functional configuration example of the analysis assist apparatus 100 is as illustrated in FIG. 3.

In the present embodiment, in step S106 of FIG. 5, the analysis-result acquisition section 104 presents the analysis-result input screen including an item in which the analysis method for each attribute is written.

The analyst writes the analysis method for each attribute in addition to writing in the items described in the first embodiment.

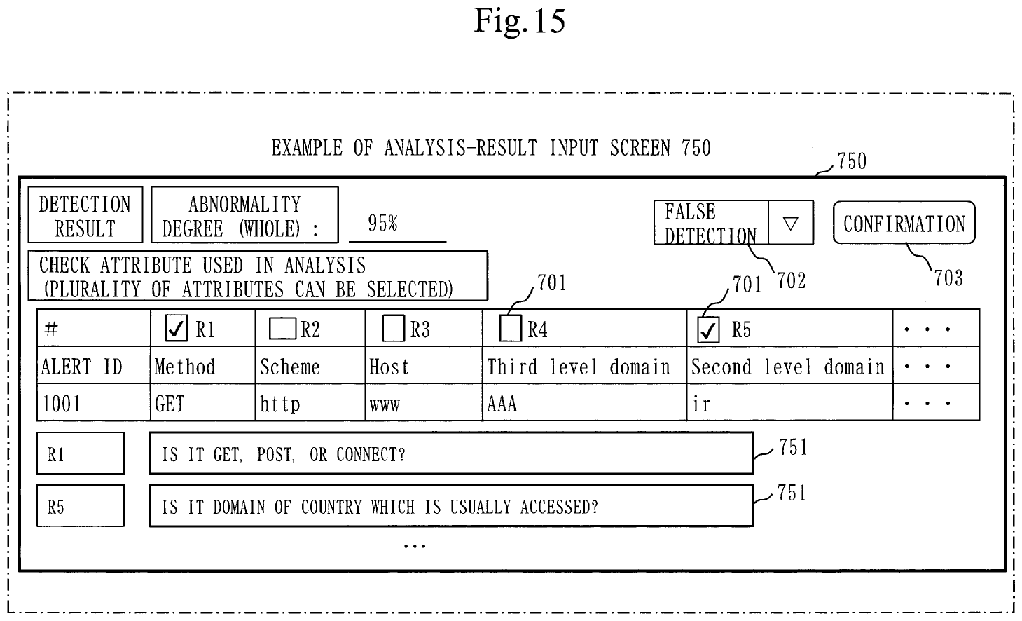

FIG. 15 illustrates an example of an analysis-result input screen 750 according to the present embodiment. The analysis-result input screen 750 of FIG. 15 illustrates a state where input by the analyst is completed.

In an analysis-result input screen 750 illustrated in FIG. 15, compared with the analysis-result input screen 700 illustrated in FIG. 6, an analysis method 751 is written for each attribute.

Then, the analysis-result acquisition section 104 stores the analysis-result input screen 750 of FIG. 15 in the analysis-result storage section 102.

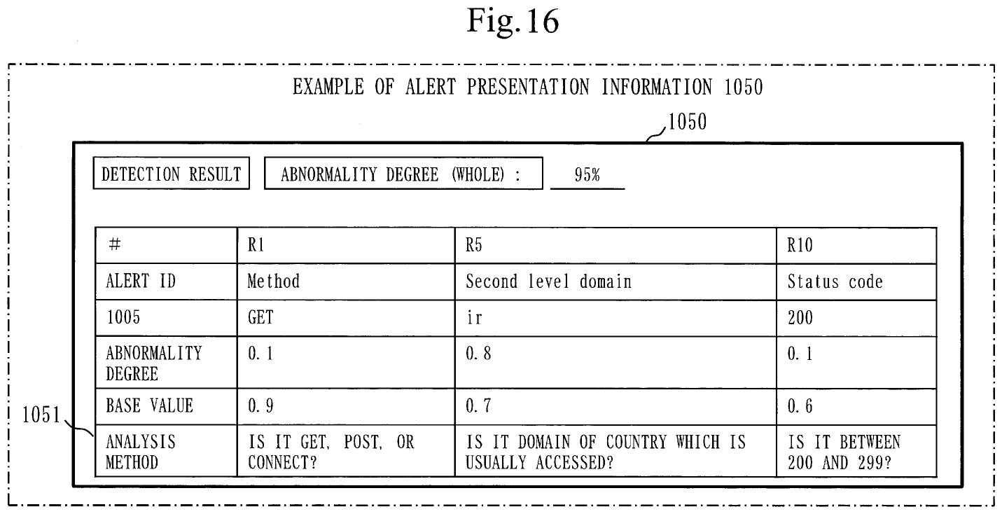

Further, in the present embodiment, in step S105 of FIG. 4, the attribute presentation section 103 presents alert presentation information 1050 illustrated in FIG. 16 to the analyst.

In the alert presentation information 1050 of FIG. 16, compared with the alert presentation information 1001 of FIG. 11, a line of an analysis method 1051 is added. Then, in the line of the analysis method 1051, an analysis method in the past anomaly analysis is indicated for each attribute.

The attribute presentation section 103 reflects on the alert presentation information 1050, descriptions of the analysis method 751 of the past anomaly analysis acquired on the analysis-result input screen 750 of FIG. 15.

Note that, in the alert presentation information 1050 of FIG. 16, the line of the analysis method 1051 is added to the alert presentation information 1001 of FIG. 11, but it is possible to add the line of the analysis method 1051 to the alert presentation information 1000 of FIG. 10.

According to the present embodiment, since the analysis method is presented for each attribute, the analyst can perform the anomaly analysis efficiently.

### Fourth Embodiment

In the present embodiment, mainly matters different from the first embodiment will be described.

Note that, matters not described below are the same as those in the first embodiment.

In the present embodiment, an example will be described of selecting the recommended attribute based on analysis status of an anomaly analysis performed in a specific period of time.

For example, for a company, a specific event takes place in a specific period of time. For example, in Japan, in April or October, events such as personnel changes and entrance of new employees to the company take place. Also, for example, an event such as a general meeting of shareholders takes place in June.

In a period of time when a specific event described above takes place, similar alert information is assumed to be generated every year.

Accordingly, in the present embodiment, the analysis-result acquisition section 104 sets a period of time for calculating the base value. Then, the analysis-result acquisition section 104 calculates the base value based on the alert information acquired in the period of time. For example, the analysis-result acquisition section 104 calculates the base value in a unit of month. Then, the analysis-result acquisition section 104 generates the base value information 109 indicating the base value for each period of time, and stores the generated base value information 109 in the analysis-result storage section 102.

In the present embodiment, the attribute selection section 101 selects the recommended attribute, using the base value of a period of time corresponding to the current time, if there exists no past alert information similar to the new alert information 107. For example, the attribute selection section 101 selects the recommended attribute, using the base value of last April when a similar event presumably has taken place.

According to the present embodiment, the recommended attribute is selected, using the base value based on the alert information collected in a period of time when a similar event presumably has taken place, thereby, it is possible to select the recommended attribute in line with an actual situation. As a result, the analyst can perform the anomaly analysis efficiently.

Although the embodiments of the present disclosure have been described above, two or more of these embodiments may be combined and implemented.

Alternatively, one of these embodiments may be partially implemented.

Alternatively, two or more of these embodiments may be partially combined and implemented.

Note that, the present disclosure is not limited to these embodiments, and various modifications can be made as necessary.

For example, when there exists past alert information similar to the alert information 107 and determination as “attack” has been made for the similar past alert information, phase information representing a progress degree of the attack may be indicated in the alert presentation information 1000. Also, an attack name may be indicated in the alert presentation information 1000. Also, a similarity degree between an attribute included in the past alert information and an attribute included in the new alert information 107 may be indicated in the alert presentation information 1000. Further, a similarity degree between the attributes may be represented in values, or visualized with a bar graph or the like.

***Description of Hardware Configuration***

Finally, supplementary descriptions of the hardware configuration of the analysis assist apparatus 100 will be given.

The processor 201 illustrated in FIG. 2 is an IC (Integrated Circuit) that performs processing.

The processor 201 is a CPU (Central Processing Unit), a DSP (Digital Signal Processor), or the like.

The memory 202 illustrated in FIG. 2 is a RAM (Random Access Memory).

The auxiliary storage device 204 illustrated in FIG. 2 is a ROM (Read Only Memory), a flash memory, an HDD (Hard Disk Drive), or the like.

The communication interface 203 illustrated in FIG. 2 is an electronic circuit that executes a communication process of data.

The communication interface 203 is, for example, a communication chip or an NIC (Network Interface Card).

The input/output interface 205 illustrated in FIG. 2 is, for example, a display device, a mouse, a keyboard, a touch panel, or the like.

The auxiliary storage device 204 also stores an OS (Operating System).

Then, at least a part of the OS is executed by the processor 201.

While executing at least the part of the OS, the processor 201 executes the programs which realize the functions of the attribute selection section 101, the attribute presentation section 103, and the analysis-result acquisition section 104.

By the processor 201 executing the OS, task management, memory management, file management, communication control, and the like are performed.

Further, at least one of information, data, a signal value, and a variable value that indicate results of processes of the attribute selection section 101, the attribute presentation section 103, and the analysis-result acquisition section 104 is stored in at least one of the memory 202, the auxiliary storage device 204, and a register and a cash memory in the processor 201.

Further, the programs which realize the functions of the attribute selection section 101, the attribute presentation section 103, and the analysis-result acquisition section 104 may be stored in a portable recording medium such as a magnetic disk, a flexible disk, an optical disc, a compact disc, a Blu-ray (registered trademark) disc, or a DVD. Further, the portable recording medium storing the programs that realize the functions of the attribute selection section 101, the attribute presentation section 103, and the analysis-result acquisition section 104 may be distributed.

Further, “section” of the attribute selection section 101, the attribute presentation section 103, and the analysis-result acquisition section 104 may be read as “circuit”, “step”. “procedure”, or “process”.

Further, the analysis assist apparatus 100 may be realized by a processing circuit. The processing circuit is, for example, a logic IC (Integrated Circuit), a GA (Gate Array), an ASIC (Application Specific Integrated Circuit), or an FPGA (Field-Programmable Gate Array).

In this case, each of the attribute selection section 101, the attribute presentation section 103, and the analysis-result acquisition section 104 is realized as a part of the processing circuit.

Note that, in the present specification, a superordinate concept of the processor and the processing circuit is referred to as “processing circuitry”.

That is, each of the processor and the processing circuit is a specific example of the “processing circuitry”.

### REFERENCE SIGNS LIST

100: analysis assist apparatus, 101: attribute selection section, 102: analysis-result storage section, 103: attribute presentation section, 104: analysis-result acquisition section. 106: subject-system log, 107: alert information, 108: analysis result information, 109: base value information, 110: correlation value information, 201: processor. 202: memory. 203: communication interface, 204: auxiliary storage device, 205: input/output interface, 301: monitoring-subject system, 302: log collection device, 303: anomaly detection apparatus, 304: similarity-degree determination section, 700: analysis-result input screen, 750: analysis-result input screen, 1000: alert presentation information, 1001: alert presentation information, 1050: alert presentation information.

1. An information processing apparatus comprising:
processing circuitry
to select, based on analysis status in a past anomaly analysis on each of a plurality of attributes of a new anomaly which is a newly detected anomaly, an attribute having a large abnormality degree in the new anomaly and being presumed, according to the past anomaly analysis, to be related with a cyber-attack in a case where an abnormality degree is large, as a recommended attribute being recommended to be emphasized in an analysis on the new anomaly, from among the plurality of attributes; and
to present the recommended attribute selected.

2. The information processing apparatus according to claim 1, wherein
the processing circuitry
determines whether or not there exists an anomaly similar to the new anomaly, which has been detected in the past, and
selects the recommended attribute when there exists no anomaly similar to the new anomaly, which has been detected in the past.

3. The information processing apparatus according to claim 1, wherein
when alert information notifying of the plurality of attributes of the new anomaly is issued, the processing circuitry selects the recommended attribute from among the plurality of attributes notified in the alert information.

4. The information processing apparatus according to claim 1, wherein
the processing circuitry selects as the recommended attribute, an attribute which has been emphasized the large number of times in the past anomaly analysis.

5. The information processing apparatus according to claim 1, wherein
the processing circuitry presents an analysis method of each attribute, which has been performed in the past anomaly analysis.

6. The information processing apparatus according to claim 1, wherein
the processing circuitry selects the recommended attribute based on analysis status in an anomaly analysis performed in a specific period of time.

7. The information processing apparatus according to claim 6, wherein
the processing circuitry selects the recommended attribute based on analysis status in an anomaly analysis performed in a specific period of time when a specific event takes place.

8. An information processing method comprising:
selecting, based on analysis status in a past anomaly analysis on each of a plurality of attributes of a new anomaly which is a newly detected anomaly, an attribute having a large abnormality degree in the new anomaly and being presumed, according to the past anomaly analysis, to be related with a cyber-attack in a case where an abnormality degree is large, as a recommended attribute being recommended to be emphasized in an analysis on the new anomaly, from among the plurality of attributes; and
presenting the recommended attribute selected.

9. A non-transitory computer readable medium storing an information processing program which causes a computer to execute:
an attribute selection process of selecting, based on analysis status in a past anomaly analysis on each of a plurality of attributes of a new anomaly which is a newly detected anomaly, an attribute having a large abnormality degree in the new anomaly and being presumed, according to the past anomaly analysis, to be related with a cyber-attack in a case where an abnormality degree is large, as a recommended attribute being recommended to be emphasized in an analysis on the new anomaly, from among the plurality of attributes, and
an attribute presentation process of presenting the recommended attribute selected by the attribute selection process.
